(19) United States
(12) Patent Application Publication
(10) Pub. No.: US 2024/0376561 A1
(43) Pub. Date: Nov. 14, 2024

(54) PRECIPITATION HARDENING MARTENSITIC STAINLESS STEEL HAVING EXCELLENT WELDABILITY, AND METHOD FOR PRODUCING THE SAME

(71) Applicant: Nippon Yakin Kogyo Co., Ltd., Tokyo (JP)

(72) Inventors: Xin JI, Kawasaki City (JP); Taiki MAEDA, Kawasaki City (JP); Fugao WEI, Kawasaki City (JP); Hidekazu TODOROKI, Kawasaki City (JP)

(73) Assignee: Nippon Yakin Kogyo Co., Ltd., Tokyo (JP)

(21) Appl. No.: 18/683,536

(22) PCT Filed: Aug. 15, 2022
(86) PCT No.: PCT/JP2022/030884

§ 371 Date: Aug. 2, 2024

(30) Foreign Application Priority Data
Aug. 19, 2021 (JP) 2021-134177

(51) Int. Cl. C21D 9/00; B22D 11/00; C21C 7/06; C21C 7/064; C21C 7/068; C21C 7/10; C21D 6/00; C21D 6/02; C21D 8/02; C22C 33/06; C22C 38/00; C22C 38/02; C22C 38/04; C22C 38/06; C22C 38/34; C22C 38/42; C22C 38/44; C22C 38/48; C22C 38/50; C22C 38/54

(52) U.S. Cl. CPC C21D 9/0081; B22D 11/002; C21C 7/06; C21C 7/0645; C21C 7/0685; C21C 7/10; C21D 6/004; C21D 6/005; C21D 6/008; C21D 6/02; C21D 8/0205; C21D 8/021; C21D 8/0226; C21D 8/0236; C21D 8/0263; C22C 33/06; C22C 38/001; C22C 38/002; C22C 38/008; C22C 38/02; C22C 38/04; C22C 38/06; C22C 38/34; C22C 38/42; C22C 38/44; C22C 38/48; C22C 38/50; C22C 38/54; C21D 2211/008

(57) ABSTRACT

[Summary]

[Assignment] A precipitation hardening martensitic stainless steel having superior strength and improved welding properties.

[Solution] In mass %, C: 0.030 to 0.065%, Si: 1.0 to 2.0%, Mn: 0.51 to 1.50%, P: not more than 0.04%, S: not more than 0.0020%, Ni: 4.0 to 10.0%, Cr: 11.0 to 18.0%, Mo: 0.1 to 1.50%, Cu: 0.30 to 6.0%, Al: 0.005 to 0.2%, Sn: 0.003 to 0.030%, N: 0.001 to 0.015%, Ti: 0.15 to 0.45%, Nb: 0.15 to 0.55%, Ca: not more than 0.0025%, Mg: 0.0001 to 0.0150%, O: not more than 0.01% and Fe and inevitable impurities as a remainder, and
satisfying the following formula (1). and δcal. (vol. %) defined by the formula (2) is in a range of 1.0 to 9.0.

Sn+0.009Cu≤0.06 (1)

δcal. (vol. %)=4.3(1.3Si+Cr+Mo+2.2Al+Ti+Nb)−3.9(30C+30N+Ni+0.8Mn+0.3Cu)−31.5 (2)

### TECHNICAL FIELD

The present invention relates to improvements in welding properties of precipitation hardening martensitic stainless steel which is appropriate for uses in which high strength is required, such as for a steel belt, high strength valve parts, welding bellows, and the like.

### BACKGROUND ART

Since precipitation hardening martensitic stainless steel can easily be made very strong by performing aging treatment on a martensitic microstructure, it is widely used for steel belts or the like, and SUS630 is one of the most notable among these steels. The steel is strengthened by precipitating an ε—Cu phase by aging heat treatment. Its final strength is about 1500 MPa.

Other than this steel, for example, Patent Documents 1 and 2 propose martensitic stainless steels in which Ti and Si are added, and propose compositions and methods for production so as to restrain softening at a welded part. This technique is to prevent a phenomenon in which martensitic structure reverse-transforms due to heat input during welding, unintended precipitation of precipitation hardening element occurs together with crystal grain coarsening, and as a result, strength and toughness may be deteriorated more than in the parent material and welded metal part. Preventative measures from this viewpoint are sufficient; however, measures against subjects which directly relate to welding execution are insufficient, such as for cracking or undercut occurring at a weld part, in practice.

Similarly, in Patent Document 3, a steel is disclosed which is based on a new strengthening mechanism in which Ti and Nb are complexed as a strengthening element. The steel has satisfactory strength; however, no measures are taken with respect to welding properties.

Furthermore, in Patent Document 4, a steel is proposed in which Al is added to realize strengthening and to improve productivity. However, oxides due to Al are easily formed at a welding bead, and application to a use in which properties of a welded part are important, such as in a steel belt, is limited.

Many kinds of measures have been suggested with respect to the requirement for strengthening as mentioned above, and measures to limit softening of a welded part have also been proposed. However, measures with respect to securing welding property, which is one of the important properties, are not sufficient.

The Patent Documents are as follows.
Patent Document 1: Japanese Unexamined Patent Application Publication No. Showa 59 (1984)-49303
Patent Document 2: Japanese Unexamined Patent Application Publication No. Heisei 05 (1993)-271769
Patent Document 3: Japanese Patent Publication No. 6776467
Patent Document 4: Japanese Patent Publication No. 4870844

### SUMMARY OF INVENTION

With respect to the requirement for strengthening precipitation hardening martensitic stainless steel, various kinds of strengthening elements have been added to realize strengthening; however, studies with respect to welding properties being subjects in use in steel belts, for example have not been performed at all. Therefore, objects of the present invention are to improve welding properties of precipitation hardening martensitic stainless steel having superior strength level, and furthermore, to provide a method for producing the stainless steel having these compositions.

The present invention has been completed in view of the above circumstances, and the precipitation hardening martensitic stainless steel of the present invention consists of: in mass %, C: 0.030 to 0.065%, Si: 1.0 to 2.0%, Mn: 0.51 to 1.50%, P: not more than 0.04%, S: not more than 0.0020%, Ni: 4.0 to 10.0%, Cr: 11.0 to 18.0%, Mo: 0.1 to 1.50%, Cu: 0.30 to 6.0%, Al: 0.005 to 0.2%, Sn: 0.003 to 0.030%, N: 0.001 to 0.015%, Ti: 0.15 to 0.45%, Nb: 0.15 to 0.55%, Ca: not more than 0.0025%, Mg: 0.0001 to 0.0150%, O: not more than 0.01% and Fe and inevitable impurities as a remainder, and satisfies the following formula (1). and δcal. (%) defined by the formula (2) is in a range of 1.0 to 9.0.

$$Sn + 0.009 Cu \leq 0.06 \qquad ( 1 )$$

$$δ cal . ( vol . \% ) = 4.3 ( 1.3 Si + Cr + Mo + 2.2 Al + Ti + Nb ) - 3.9 ( 30 C + 30 N + Ni + 0.8 Mn + 0.3 Cu ) - 31.5 \qquad ( 2 )$$

It is desirable that the precipitation hardening martensitic stainless steel of the present invention contain B: 0.0010 to 0.0020%.

It is desirable that the precipitation hardening martensitic stainless steel of the present invention satisfy the formula (3).

$$Nb - Ti > 0 \qquad ( 3 )$$

Furthermore, the method for production of the precipitation hardening martensitic stainless steel of the present invention includes the following steps: melting raw material of Ni alloy scrap, iron scrap or stainless scrap, ferrochromium, ferronickel, pure nickel, metallic chromium in an electric furnace, blowing oxygen gas and/or argon gas to perform decarburization and refining in an AOD furnace or VOD furnace in which magnesia-chrome or dolomite is lined as a refractory material, forming CaO—SiO₂—Al₂O₃—MgO—F type slag comprising CaO: 40 to 70%, SiO₂: 1 to 20%, Al₂O₃: 5 to 20%, MgO: 5 to 20%, F: 1 to 10% and performing desulfurizing and deoxidizing by placing calcined lime, fluorite, Al and Si, refining in the AOD furnace or VOD furnace by placing a Ti source and a Nb source, adjusting compositions and temperature in LF process, producing rectangular slab by a continuous casting, hot rolling, cold rolling if necessary, and performing solution heat treatment.

It is desirable that the solution heat treatment be performed at 900 to 1150° C. in production of the precipitation hardening martensitic stainless steel of the present invention.

### BRIEF DESCRIPTION OF DRAWINGS

FIG. 1A is a graph showing effect of Si amount on weld penetration, and FIG. 1B is a graph showing effect of Si amount affecting welding bead width.

FIG. 2A is a graph showing effect of Al amount affecting number of concave and convex parts on welding bead, and FIG. 2B is a graph showing effect of Ti amount affecting number of concave and convex on welding bead.

FIG. 3 is a graph showing effect of Ti and Nb addition amounts affecting number of concave and convex parts on the welding bead.

FIG. 4 is a graph showing effect of Cu amount affecting occurrence of welding cracking in Varestraint testing.

FIG. 5 is a graph showing effect of Cu and Sn amount affecting occurrence of welding cracking.

### EMBODIMENTS OF INVENTION

Welding of a steel belt is generally performed by forming I beveling and welding in one pass, without using welding filler. After welding by heat input of a requisite minimum, removal of welding beads at the front and back to a plate thickness of the parent material, that is, bead cut, is employed. However, belts tend to be thicker recently, and a steel belt having a plate thickness greater than 3.5 mmt for example, in which welding cannot be finished in one pass has been practically realized. Furthermore, there are strong requirements for widening, and a belt having a width of 5 feet has been practically realized. In such recent situations, improved welding properties under severe conditions are required than before. Although welding filler is not used as conventionally, since 3 or 4 welding passes are necessary, it is necessary that (1) defects such as cracking not occur during welding even if welded with heat input greater than conventionally, and (2) since oxidized scale on the surface of the bead is removed between each of the passes, generation of oxidized scale should be small, a surface of a bead should be flat so as to facilitate treatment, and the above conditions are required even if welding is performed along a length of 5 feet. In particular, since welding defects may occur in a next pass in a case in which treatment of (2) is insufficient, surface conditions should be better.

The inventors have researched in order to solve the above matters. In order to impart superior welding properties, the inventors have researched widely with respect to compositions in which properties of penetration, welding cracking resistance, and bead shape can be maintained even if welding with a large heat input is performed on a material having greater plate thickness than conventionally.

14.2% Cr-6.8% Ni-1.5% Si-0.7% Mo-0.7% Cu-0.35% Ti-0.35% Nb was selected as a basic composition, concentrations of elements of interest were variously changed within ranges shown in Table 1, and melting was performed on a laboratory scale. Since this purposes on studying wide composition ranges, concentrations of elements of basic components were also changed. Melting was performed using a high frequency induction furnace and with 10 kg in each case. After that, hot forging was performed to have thickness of 5.3 mmt. Furthermore, solution heat treatment of 1050° C.×5 minutes was performed, cooled by water, pickled by acid, and applied to various kinds of tests. Since plate thickness should be aligned to evaluate penetration properties, thickness was adjusted to 5.0 mmt by a shaper from both surfaces so as to be evaluated. Surface finishing was “∇∇∇” (three reversed triangles, meaning minor mirror finishing, in the Japanese Industrial Standard symbol). If the plate thickness is thick, heat loss is large, and it is more difficult to maintain penetration properties. In this way, a situation that is possible to realize in a practical producing process is considered, and a plate thickness of 5 mmt was selected.

Two tests were performed using this sample. One of them was bead-on-plate test in one pass by TIG welding. Welding conditions were set as follows, welding current: 125A, welding speed: 80 mm/min, seal gas: Ar+3% H₂, 15 L/min. With respect to the welded sample, (1) depth and width of penetration were evaluated by observation of cross section and (2) appearance (concave and convex part) was evaluated.

TABLE 1

| C | Si | Mn | S | Ni | Cr | Mo | Cu |
|---|---|---|---|---|---|---|---|
| ~0.065% | ~2.6% | ~2.0% | 0.0005~0.0015% | 5~7% | 12.5~16.0% | ~2.0% | ~6.6% |

| Al | Ti | Nb | Sn | B | Mg | Ca |
|---|---|---|---|---|---|---|
| ~0.25% | ~0.55% | ~0.55% | ~0.045% | ~0.005% | ~0.025% | ~0.0030% |

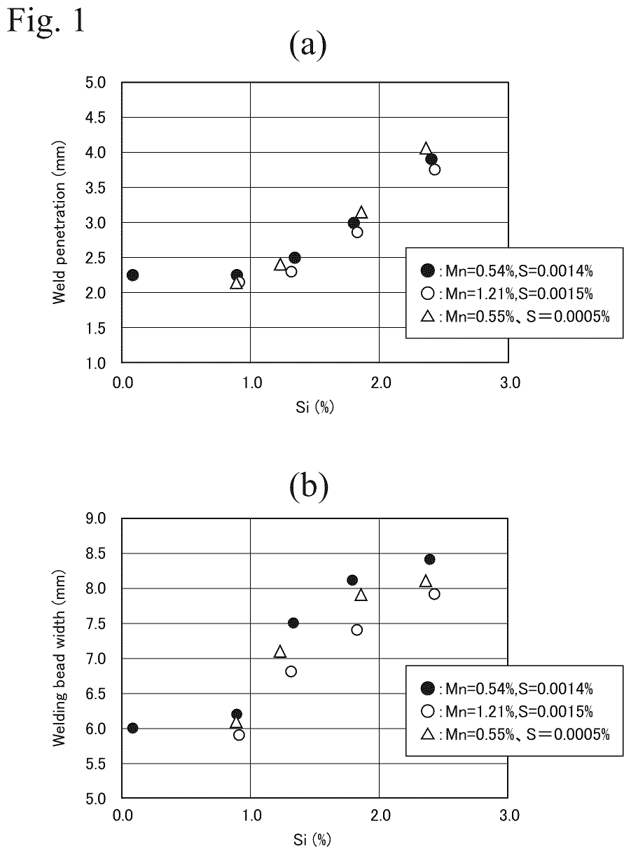

Study results of effect of Si on weld penetration properties are shown in FIG. 1. As Si amount was increased, weld penetration depth became deeper. A tendency was observed that bead width also became larger according to this. This is not desirable because enlargement of bead width means a tendency to have a concave shape. Then, by varying the kinds of elements, the inventors researched to find an element which effectively deepens only weld penetration depth, without enlarging bead width. As a result, it became obvious that although weld penetration depth may be slightly shallow if amount of Mn is increased, widening of bead width is restrained. Similarly, it became obvious that weld penetration depth may change little if the amount of S is reduced, and on the other hand, widening of bead width is restrained. It became obvious that although addition of Si is necessary to impart aging hardening properties, in order to restrain widening of bead width due to the addition, it is necessary that the amount of Mn be appropriate and the amount of S be reduced.

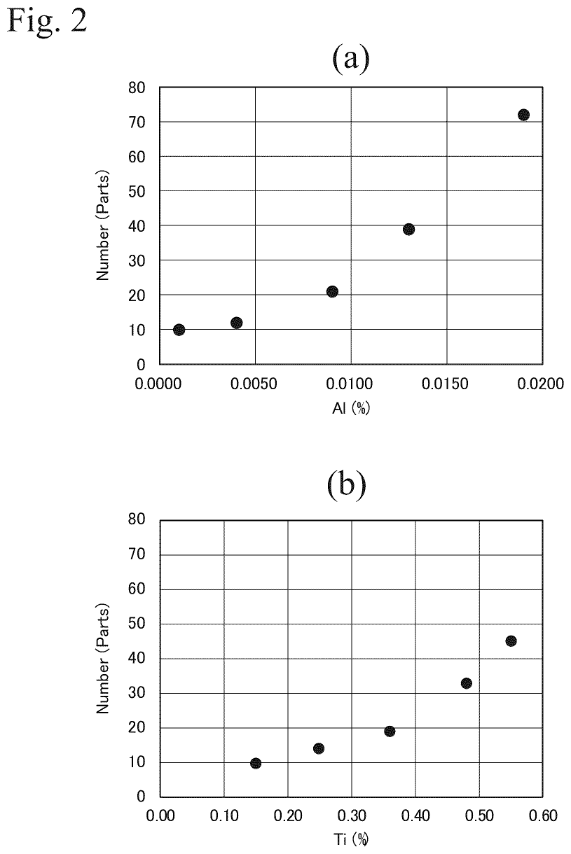

Next, a location near a finishing point at which the welding bead after welding was sufficiently stabilized was selected, the number of concave and convex parts having height not less than 0.2 mm in a bead length 30 mm was measured by a color 3D laser microscope (trade name: VK-9719, produced by Keyence corporation) and evaluated. Here, the reason for setting a criterion for the height of concave and convex parts at 0.2 mm was that the time required for grinder polishing performed after one pass of welding and before the next welding may be long. The concave and convex parts on the welding bead were of various kinds such as oxides, nitrides, or mixture thereof, but constituent elements were mainly Al, Ti, N, and O, and in some cases, constituent elements were Mg and Ca observed. On the other hand, little Nb was observed, and therefore, it was decided that Nb did not have a tendency to worsen concave and convex parts. Effect of Al and Ti amounts on number of concave and convex parts is shown in FIG. 2. In each element, number of concave and convex parts was increased as the addition amount was increased. Therefore, it is desirable to reduce the amounts as much as possible to improve the welding bead concave and convex parts. Ti is difficult to reduce since Ti is an important element which causes aging hardening. Therefore, it is necessary to strictly limit the amount of Al.

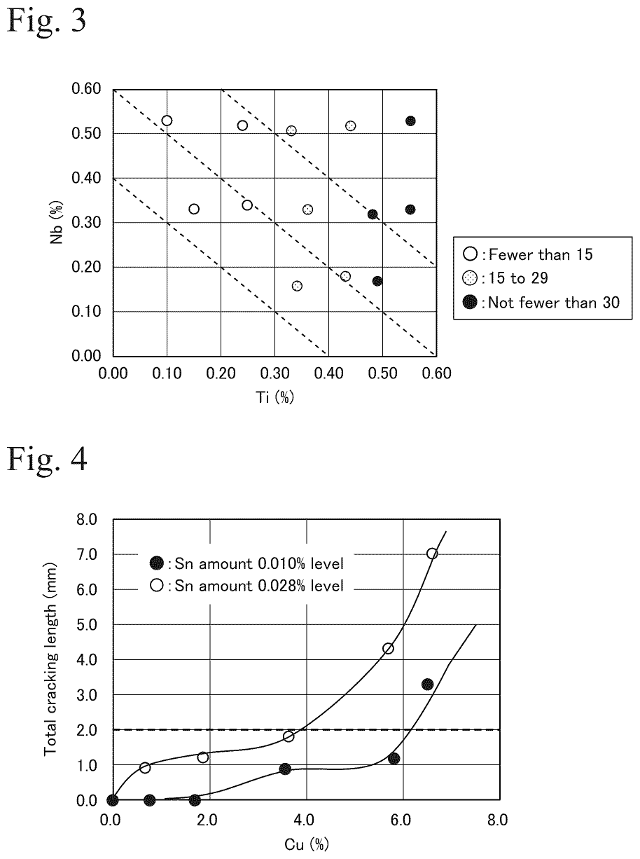

Since Nb, which exhibits aging hardening properties, was not observed in the concave and convex parts, it was suggested that Nb should be utilized. As a result of confirming this, effects of Ti and Nb addition amounts on number of concave and convex parts on welding bead is shown in FIG. 3. As a result of varying Ti and Nb amounts to different degrees and evaluating, number of concave and convex parts did not change very much even if the amount of Nb was large, and thus, it became clear that the amount of Ti should be controlled. Both Ti and Nb cause large degrees of hardening if they are increased. As shown in this figure, from the viewpoint of the sum of the amounts of Ti and Nb, for example, a dotted line of Ti+Nb=0.6% indicates there was improvement as the ratio of Nb amount increased. Therefore, it became obvious that concave and convex parts may be reduced by setting Nb>Ti in the addition amount of hardening elements Ti and Nb. In addition, since Mg and Ca were observed, the upper limit of these elements should be limited.

As one more test, a Trans-varestraint test was performed to study whether cracking occurred or did not occur in welding. The size of the test piece of the above sample material was 5.0 t×65 w×130l, and the testing apparatus was BTM-380 produced by MIYAKOJIMA SEISAKUSHO CO., LTD. Conditions of TIG welding were set to be welding current 120 A, welding speed 100 mm/min, seal gas Ar, and flowing amount 15 L/min. Since bending jig of 500 R was used, it was calculated that distortion of 0.5% was imparted at the surface. Assuming that a steel belt was to be produced, extremely small distortion was used, that is, the distorting rate was set to be 10 mm/sec. Test results evaluation was performed by occurrence of cracking, measurement of overall length of cracking by observation at 50 times magnification to see if there was cracking, and the total cracking length was the sum of the cracks.

A result of evaluation of the effect of the amount of Cu under basically constant Sn amount is shown in FIG. 4. From the figure, it was obvious that the length of each crack and the total cracking length were longer as the amount of Cu was increased, and that cracking occurred in a region containing a small amount of Cu if the Sn amount was large. It is desirable that the number of cracks be zero from the viewpoint of bead processing; however, if the total cracking length was about 2 mm, each cracking depth was not more than 1 mm, and they could be easily removed by bead processing. Therefore, the threshold value was set to be 2 mm.

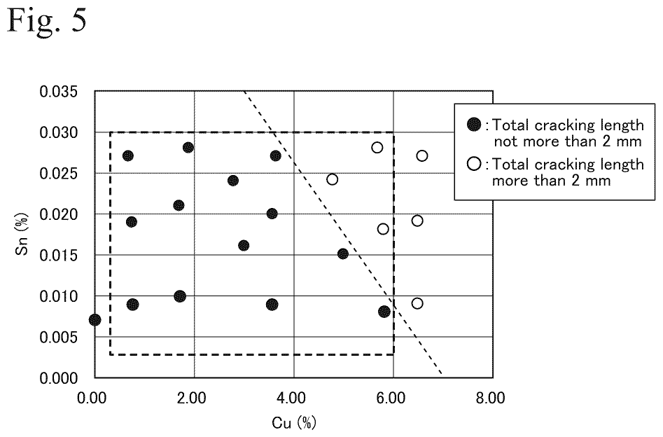

From these evaluations, a relationship between Cu and Sn amounts and the total cracking length is shown in FIG. 5. It became clear that there was an unfavorable range in which there was a lot of cracking if Cu and Sn amounts were large. A borderline was set in this figure so that the formula (1) was obtained, indicating a range of possible Sn addition to restrain cracking during welding, with respect to Cu amount imparting aging hardening properties.

$$Sn + 0.009 Cu \leq 0.06 \qquad ( 1 )$$

As a result of evaluation by a similar method, it was confirmed that reduction in S and P were effective, control by a calculation formula δcal. indicated by formula (2) was also effective, and furthermore, addition of B promoted cracking, and this was particularly noticeable in the presence of Nb.

Next, reasons for limitations of each of the compositions are explained.

### C: 0.030 to 0.065%

C is an element stabilizing the austenitic phase, and an element to be controlled so as to restrain generation of the δ ferritic phase. It is an important element contributing strengthening of martensitic phase if contained, and exhibiting strength in the present invention. Therefore, its lower limit is set to be 0.030%. However, if contained excessively, it may cause the retained austenitic phase to increase, adversely decreasing strength. Furthermore, flowability of melt metal may be too high so that it be difficult to control the welding bead shape into an ideal convex shape. Therefore, its upper limit is set to be 0.065%. It is desirably 0.032 to 0.060, and more desirably 0.035 to 0.050%.

### Si: 1.0 to 2.0%

Si is an element added for deoxidation, and in the present invention, it is an important element required to obtain strength, having a function precipitating the G phase by aging heat treatment. In addition, it is a necessary element to improve weld penetration during welding. It is necessary to add not less than 1.0% to obtain these effects. However, if added excessively, the δ ferritic phase may increase so as to deteriorate hot workability, and furthermore, weld penetration may be excessively improved so as to cause a situation in which controlling the welding bead into the ideal convex shape is difficult. Therefore, the upper limit is set to be 2.0%. It is desirably 1.20 to 1.85%, and more desirably 1.30 to 1.80%.

### Mn: 0.51 to 1.50%

Since Mn is an element stabilizing the austenitic phase and has an effect of restraining generation of the δ ferritic phase. Furthermore, in a case of the present invention steel in which Si addition is necessary it has an effect to restrain excessive improvement of weld penetration properties by Si. Therefore, it is necessary to add not less than 0.51%. However, if contained excessively, the retained austenitic phase may increase, thereby deteriorating strength. Furthermore, MnS may be formed and corrosion resistance may be deteriorated. Therefore, the upper limit is set to be 1.50%. It is desirably 0.70 to 1.35% and more desirably 0.75 to 1.25%.

P: Not more than 0.04%

P is an element which is inevitably a contaminant in steel, and it may segregate at the crystal grain boundary, be concentrated at a final solidifying part during continuous casting and welding, promote solidification cracking, and furthermore, cause deterioration of hot workability. Therefore, it is desirable to reduce it as much as possible. However, production cost may be increased if an attempt is made to reduce it extremely, and the upper limit is set to be 0.04%. It is desirably 0.035% and more desirably 0.030%.

S: Not more than 0.0020%

S is an element which is inevitably a contaminant in steel, similar to P, and it is desirable to reduce it as much as possible since it may combine with Mn so as to form inclusions (MnS) and to deteriorate corrosion resistance. Furthermore, since it may segregate at a grain boundary so as to reduce hot workability, it is necessary to reduce it from this viewpoint. Therefore, the upper limit is set to be 0.0020%. It is desirably not more than 0.0015%, and more desirably not more than 0.0010%. To control S amount in this range, it is important to control Al concentration and slab concentration in a range of the present invention.

$$3 ( CaO ) + 2 \underline{Al} + 3 \underline{S} = 2 ( {Al}_{2} {O}_{3} ) + 3 ( CaS ) \qquad ( A )$$

Symbol in the bracket and the underlined part indicate compositions in the slag and compositions in steel, respectively. It is possible that by addition Al, the (A) formula may be promoted, and S can be controlled into the above S concentration.

### Ni: 4.0 to 10.0%

Ni is an element which stabilizes the austenitic phase, and it has an effect of restraining generation of the δ ferritic phase. Furthermore, it is one of the important elements in the present invention in which the G phase is formed by aging heat treatment so as to contribute to strengthening. It is necessary to add not less than 4.0% in order to obtain these effects. However, if added excessively, the retained austenitic phase may be increased and reduce strength. Therefore, the upper limit is set to be 10.0%. It is desirably 6.0 to 9.0%, and more desirably 6.5 to 8.5%.

### Cr: 11.0 to 18.0%

Cr is a necessary element in order to maintain corrosion resistance, and it is necessary to be at least 11.0%. However, if added excessively, generation of the δ ferritic phase may be promoted and deteriorate hot workability. Therefore, the upper limit is set to be 18.0%. It is desirably 12.0 to 17.0%, and more desirably 13.0 to 16.0%.

### Mo: 0.1 to 1.50%

Mo is a necessary element in order to maintain corrosion resistance, it is necessary to add at least 0.1%. However, if added excessively, generation of the δ ferritic phase may be promoted and deteriorate hot workability. Therefore, the upper limit is set to be 1.50%. It is desirably 0.6 to 1.20%, and more desirably 0.7 to 1.00%.

### Cu: 0.30 to 6.0%

Cu is an element which stabilizes the austenitic phase, it has an effect to restrain generation of the δ ferritic phase. Furthermore, it is one of the important elements in the present invention in which the Cu phase is formed by aging heat treatment so as to contribute to strengthening, and it is necessary to add at least 0.30%. However, if added excessively, the retained austenitic phase may be increased and deteriorate hot workability. In addition, it may promote occurrence of welding cracking by coexistence with Sn, therefore, the upper limit is set to be 6.0%. It is desirably 0.40 to 4.0%, and more desirably 0.50 to 2.0%.

### Al: 0.005 to 0.2%

Al is an element which is added for deoxidation, and it is a necessary element which makes Nb and Ti be reliably contained, which are easily oxidized and exhibit inferior yield ratio of addition in molten metal.

$$3 ( NbO ) + 2 \underline{Al} = ( {Al}_{2} {O}_{3} ) + 3 \underline{Nb} \qquad ( B )$$

$$3 ( {TiO}_{2} ) + 4 \underline{Al} = 2 ( {Al}_{2} {O}_{3} ) + 3 \underline{Ti} \qquad ( C )$$

In order to promote reaction toward the right side in the formulas (B) and (C) sufficiently and to yield Nb and Ti in melt metal, it is necessary to add at least 0.005%. Furthermore, it is an element which heightens martensitic transformation starting temperature, and a useful element which can be used for controlling of the Ms point. Therefore, it is necessary to add not less than 0.005%. However, if added excessively, the δ ferritic phase may be increased and hot workability may be deteriorated. Furthermore, it may excessively reduce CaO and MgO in the slag, and therefore Ca and Mg contents may exceed the ranges of the present invention.

$$3 ( CaO ) + 2 \underline{Al} = ( {Al}_{2} {O}_{3} ) + 3 \underline{Ca} \qquad ( D )$$

$$3 ( MgO ) + 2 \underline{Al} = ( {Al}_{2} {O}_{3} ) + 3 \underline{Mg} \qquad ( E )$$

Furthermore, since formation of foreign substances may be promoted on the welding bead so as to increase concave and convex part, the upper limit is set to be 0.2%. It is desirably 0.007 to 0.017%, and more desirably 0.009 to 0.015%.

### Sn: 0.003 to 0.030%

Sn is a useful element which improves corrosion resistance even by addition of small amount. To obtain the effect, it is necessary to add at least 0.003%. However, if added excessively, welding cracking may occur, and in particular, in the present invention steel in which Cu is a necessary element, the upper limit is limited to 0.030%. It is desirably 0.004 to 0.025% and more desirably 0.005 to 0.020%.

### N: 0.001 to 0.015%

N is an element which stabilizes the austenitic phase, and it is an element which should be controlled in order to restrain generation of the δ ferritic phase. It is an important element which contributes to strengthening of the martensitic phase and exhibits strength in the present invention by containing it. Therefore, the lower limit is set to be 0.001%. However, if contained excessively, retained austenitic phase may be increased, and on the other hand, strength may be deteriorated. Furthermore, it may mainly form nitrides with Ti, and cause deterioration in ductility. Therefore, the upper limit is set to be 0.015%. It is desirably 0.002 to 0.013%, and more desirably 0.003 to 0.010%

### Ti: 0.15 to 0.45%

Ti is an important element which forms the G phase with Si, Ni and Nb, and contributes to strengthening by aging heat treatment. To obtain these effects, it is necessary to add not less than 0.15%. However, if added excessively, the δ ferritic phase may be increased, and hot workability may be deteriorated. Furthermore, since it may increase viscosity of molten metal, thereby increasing size of concave and convex part on the surface of welding bead and increasing effort to treat by welding. Therefore, the upper limit is set to be 0.45%. It is desirably 0.20 to 0.40%, and more desirably 0.25 to 0.35%. It is important that Al is controlled into the Al concentration of the present invention in order to add Ti efficiently into the range of the present invention.

### Nb: 0.15 to 0.55%

Nb is an important element which forms the G phase with Si, Ni and Nb and contributes to strengthening by aging heat treatment. Ti which has same effect as Nb may worsen the welding bead shape; however, Nb has the less tendency of worsening, thus, it is an element which should be added preferentially. Therefore, it is necessary to add not less than 0.15%. However, if added excessively, the δ ferritic phase may be increased and may deteriorate hot workability. Therefore, the upper limit is set to be 0.55%. It is desirably 0.20 to 0.50%, and more desirably 0.25 to 0.45%. It is important that Al is controlled into the Al concentration of the present invention in order to add Nb efficiently into the range of the present invention.

Sn−0.009Cu≤0.06

This is a relationship formula necessary in order to restrain cracking at a welded part and obtain a good welding bead. Cracking can be effectively restrained by controlling Cu and Sn amounts. Cu and Sn amounts are controlled to satisfy this relationship formula.

(1)′ is desirable and (1)″ is more desirable.

$$Sn - 0.009 Cu \leq 0.055 \qquad {( 1 )}^{′}$$

$$Sn - 0.009 Cu \leq 0.045 \qquad {( 1 )}^{″}$$

$$δ cal . ( vol . \% ) 1. to 9. \%$$

$$δ cal . ( vol . \% ) = 4.3 ( 1.3 Si + Cr + Mo + 2.2 Al + Ti + Nb ) - 3.9 ( 30 C + 30 N + Ni + 0.8 Mn + 0.3 Cu ) - 31.5$$

δcal. is a calculation formula which estimates volume % of the δ ferritic phase generated in a slab produced by continuous casting, and similarly, which also estimates δ ferritic phase in a welding bead. The term Ti is added so as to be employed in the present invention. An element symbol in the formula indicates content (mass %) of the corresponding composition. In a case in which this value is less than 1.0%, frequency of occurrence of solidification cracking may be increased if employing welding with a large heat input. On the other hand, in a case in which the value is greater than 9.0%, sufficient hardening may not be obtained if performing aging heat treatment on a welded part as it is. Therefore, it is necessary to control it within a range of 1.0 to 9.0%. It is desirably 2.0 to 7.0%, and more desirably 2.5 to 6.5%.

Ca: Not more than 0.0025%

Ca is an element which is added from the slab according to the formula (D). It may worsen properties on the surface of welding bead, and worsen polishing properties by being oxides. Ca concentration can be controlled in lower level by controlling Al concentration and slag composition into the range and composition of the present invention. In this way, it is necessary to be not more than 0.0025%. It is desirably not more than 0.0015% and more desirably not more than 0.0010%.

O: Not more than 0.01%

It may form oxides with Si, Al, Mg or the like to be inclusions, thereby deteriorating corrosion resistance and toughness. Furthermore, it may float on the welding bead thereby extremely increasing effort to remove it. In order to control in this range, Al concentration should be controlled in the range of the present invention. In this way, it is necessary to be not more than 0.01% by reducing as much as possible. It is desirably not more than 0.0070%, and more desirably not more than 0.0050%.

### B: 0.0010 to 0.0020%

B is added to improve hot workability, and to obtain the effect, it is necessary to add not less than 0.0010%. However, solidified cracking and cracking during welding may be promoted if added more than 0.0020%. In particular, cracking is noticeable in a case in which Nb amount is large. Therefore, the content is set to be 0.0010 to 0.0020%. It is desirably 0.0011 to 0.0019%, and more desirably 0.0012 to 0.0018%.

### Mg: 0.0001 to 0.0150%

Mg is an element which improves hot workability by adding it. Therefore, it is added not less than 0.0001%. However, if Mg is added not less than a certain amount, inclusions may increase and appearance of welding bead may be deteriorated. Furthermore, hot workability may be extremely deteriorated. Therefore, the upper limit is set to be 0.0150%. It is desirably 0.0005 to 0.0130%, and more desirably 0.001 to 0.0100%. In order to control in this range, it may be supplied from the slag according to the formula (E).

$$Nb - Ti > 0$$

In the present invention, two elements, that is, Ti and Nb, are added in combination and utilized in order to form a G-phase. In a case in which Ti is the main component for strengthening, this is not desirable since viscosity of the molten metal may be increased, concave and convex parts may be formed on the bead of the welded part, and much effort may be required to correct it. Therefore, in the manner of the present invention, the main component for strengthening is Nb, and when strengthening is required, the amount of Nb is increased. Therefore, it is set to be Nb−Ti>0. It is desirable that Nb−Ti≥0.05, and it is more desirable that Nb−Ti≥0.10.

The remainder other than the compositions mentioned above of the precipitation hardening martensitic stainless steel of the present invention consists of Fe and inevitable impurities. Here, the inevitable impurities are components which are inevitable contaminants for various reasons during industrial stainless steel production, and it means a component allowed to be contained in a range not adversely affecting the action and effect of the present invention.

Next, a method for producing the precipitation hardening martensitic stainless steel of the present invention is explained. First, raw materials such as Ni alloy scrap, iron scrap, stainless steel scrap, ferrochromium, ferronickel, pure nickel, and metallic chromium are melted in an electric furnace. After that, in an AOD furnace or a VOD furnace, together with decarburizing and refining by blowing oxygen gas and argon gas, calcined lime, fluorite, Al, Si and the like are placed so as to perform desulfurizing and deoxidizing processes. It is desirable that refractory material of the AOD furnace and VOD furnace be magnesia-chrome or dolomite. After that, Ti and Nb are added. It is necessary that slag compositions in the process to be formed is of the CaO—SiO₂—Al₂O₃—MgO—F type including CaO: 40 to 70%, SiO₂: 1 to 20%, Al₂O₃ 5 to 20%, MgO): 5 to 20%, and F: 1 to 10%. Basically, as explained above, the slab composition is necessary for deoxidation, desulfurization, improvement in yields of Ti and Nb, that is, contribution to accurate addition thereof, and control of Ca and Mg within the range of the present invention. The reasons for limiting the slag composition are explained as follows.

### CaO: 40 to 70%

CaO is an extremely important component. In a case in which it is less than 40%, effect of deoxidation by Al may be decreased and oxygen and sulfur concentrations may be increased. However, in a case in which it is greater than 70%, Ca may be excessively supplied to molten metal, and Ca concentration may exceed the range of the present invention. Therefore, it is set to be 40 to 70%. CaO concentration is controlled by calcined lime.

### SiO₂: 1 to 20%

SiO₂ is a component which contributes to flowability of the molten slag. It is necessary to add at least 1%, and in a case in which it is added at more than 20%, flowability may be too high, and may cause damage on the refractory material. Therefore, it is set to be 1 to 20%. SiO₂ concentration is controlled by Si amount during deoxidation.

Al₂O₃ 5 to 20%

Al₂O₃ is a necessary component in order to control Al concentration in the molten metal in the range of the present invention. Therefore, it is set to be 5 to 20%.

### MgO: 5 to 20%

MgO is an important component to supply Mg in the molten metal. Therefore, it is necessary to add at least 5%; however, in a case in which it is more than 20%, flowability may be deteriorated and slag-off cannot be performed. Therefore, it is set to be 5 to 20%. MgO is controlled by addition of MgO source such as waste brick.

### F: 1 to 10%.

F is a necessary component to improve flowability of the slab. In a case it is too low, flowability may be deteriorated. In a case in which it is too high, flowability may be too high and may damage brick. Therefore, it is set to be 1 to 10%. Furthermore, in order to improve yields of Nb and Ti, NbO and TiO₂ in the slag are limited as follows.

NbO: Not more than 1%

It is necessary that NbO be controlled to not more than 1%, in order to control Nb in the concentration of the present invention. This can be achieved by controlling Al in the range of the present invention according to the formula (B).

TiO₂: Not more than 1%

It is necessary that TiO₂ concentration be not more than 1% in order to control Ti in the concentration of the present invention. This can be achieved by controlling Al in the range of the present invention according to the formula (C).

After refining by the AOD furnace or the like, compositions are adjusted by LF process, temperature is adjusted, a rectangular slab is produced by continuous casting, the slab is hot-rolled, the slab is cold-rolled if necessary, and solution heat treatment is performed at a predetermined plate thickness so as to obtain a product. It is necessary to perform solution heat treatment at 900 to 1150° C. The reason is that in a case in which it is performed at less than 900° C., re-solid solution of precipitation strengthening element, carbide, or the like, may not be sufficient, strength may not be increased sufficiently by aging treatment performed thereafter, or corrosion resistance may be deteriorated. On the other hand, in a case in which heat treatment is performed at greater than 1150° C., crystal grain size may be coarse, toughness may be extremely deteriorated, and service life as a steel belt may not be adequate. Therefore, it is necessary to perform heat treatment in a range of 900 to 1150° C. It is desirably 950 to 1100° C., and more desirably 980 to 1075° C. Furthermore, it is desirable to keep retention time not less than 15 seconds. The reason is that soaking of heat of the entirety of a product is ensured, and minimizing unevenness of partial strength and toughness. The time should be appropriately set in view of plate thickness. It is desirably not less than 30 seconds, and more desirably not less than 1 minute.

### Examples

Hereinafter, the present invention is explained further in detail with reference to Examples. It should be noted that the present invention is not limited to these Examples unless they are outside the range thereof. First, raw materials such as Ni alloy scrap, iron scrap, stainless steel scrap, ferrochromium, ferronickel, pure nickel, metallic chromium and the like were melted in an electric furnace. After that, in the AOD furnace or VOD furnace, oxygen gas and argon gas were blown together to perform decarburization and refining, and calcined lime, fluorite, Al, and Si were added to perform desulfurization and deoxidation. In this process, CaO—SiO₂—Al₂O₃—MgO—F type slag was formed, and Nb and Ti were added. After the refining by the AOD furnace or the like, compositions and temperature were adjusted in LF process, casting was performed by a continuous casting apparatus so as to obtain a rectangular slab. The width was 1650 mm, and chemical compositions of each sample are shown in Table 2.

TABLE 2

| | | C | Si | Mn | P | S | Ni | Cr | Mo | Cu | Al | Ti | Nb | Sn | N | Sn [symbol] | [symbol] cal |
|---|---|---|---|---|---|---|---|---|---|---|---|---|---|---|---|---|---|
| Examples | 1 | [symbol] | 1.07 | [symbol] | [symbol] | 0.0015 | [symbol] | 17.7 | 1.47 | 0.32 | 0.008 | 0.42 | 0.15 | 0.029 | 0.014 | 0.032 | 7.1 |
| | 2 | [symbol] | [symbol] | [symbol] | [symbol] | 0.0014 | [symbol] | 11.0 | 1.34 | 5.51 | 0.010 | 0.18 | 0.64 | 0.003 | 0.001 | 0.053 | 3.1 |
| | 3 | 0.001 | [symbol] | [symbol] | [symbol] | 0.0014 | [symbol] | 11.9 | 0.13 | 3.60 | 0.051 | 0.44 | 0.51 | 0.028 | 0.015 | 0.060 | 1.9 |
| | 4 | 0.033 | 1.21 | 0.51 | 0.031 | 0.0012 | [symbol] | [symbol] | 0.85 | 0.43 | 0.012 | 0.21 | 0.19 | 0.004 | 0.011 | [symbol] | 8.3 |
| | 5 | [symbol] | [symbol] | 1.29 | 0.032 | 0.0011 | [symbol] | [symbol] | 0.25 | [symbol] | 0.008 | 0.15 | 0.48 | 0.004 | 0.002 | [symbol] | 9.0 |
| | 6 | [symbol] | [symbol] | 0.71 | 0.033 | 0.0012 | [symbol] | 12.3 | 1.19 | 2.1 | 0.193 | 0.39 | 0.47 | 0.021 | 0.002 | 0.040 | 3.7 |
| | 7 | [symbol] | 1.81 | 1.35 | 0.031 | 0.0011 | [symbol] | 12.8 | 1.03 | 3.3 | 0.006 | 0.24 | 0.24 | 0.024 | 0.013 | 0.058 | 2.7 |
| | 8 | [symbol] | 1.04 | 1.11 | 0.015 | 0.0001 | [symbol] | 13.2 | [symbol] | 1.9 | 0.121 | 0.30 | 0.42 | [symbol] | 0.009 | 0.025 | 8.5 |
| | 9 | [symbol] | 1.78 | 1.24 | 0.025 | 0.0005 | [symbol] | 13.2 | 0.08 | 0.61 | 0.092 | 0.26 | 0.44 | 0.019 | 0.008 | 0.024 | 6.1 |
| | 10 | 0.041 | 1.32 | 0.80 | 0.017 | 0.0007 | [symbol] | 13.6 | 0.81 | 0.77 | 0.007 | 0.31 | 0.39 | 0.012 | 0.004 | 0.019 | 6.4 |
| | 11 | 0.035 | 1.44 | 0.03 | 0.030 | 0.0008 | [symbol] | 14.7 | 0.72 | 1.8 | 0.008 | 0.26 | 0.38 | 0.017 | 0.005 | 0.031 | 8.6 |
| | 12 | 0.035 | [symbol] | 1.03 | 0.028 | 0.0004 | [symbol] | 13.9 | [symbol] | 0.05 | 0.052 | 0.30 | 0.29 | 0.009 | 0.007 | 0.017 | 2.3 |
| | 13 | 0.040 | 1.71 | 0.77 | 0.020 | 0.0008 | [symbol] | 14.3 | 0.75 | 1.1 | 0.005 | 0.34 | [symbol] | 0.014 | 0.006 | 0.024 | 5.4 |
| | 14 | 0.044 | 1.59 | 0.99 | 0.027 | 0.0005 | [symbol] | 15.7 | 0.74 | 1.9 | 0.101 | 0.33 | 0.27 | 0.007 | 0.009 | 0.024 | 8.3 |
| | 15 | 0.035 | 1.67 | 1.04 | 0.028 | 0.0008 | [symbol] | 13.9 | [symbol] | 0.05 | [symbol] | 0.29 | [symbol] | 0.009 | 0.007 | 0.017 | 1.9 |
| | 16 | 0.035 | 1.42 | 0.93 | 0.020 | 0.0008 | 7.1 | 14.6 | [symbol] | 1.5 | 0.005 | 0.28 | 0.38 | 0.018 | 0.005 | 0.022 | 7.7 |
| | 17 | 0.040 | 1.78 | 1.24 | 0.017 | 0.0003 | 6.8 | 13.9 | [symbol] | 0.01 | 0.007 | 0.76 | 0.44 | 0.018 | 0.000 | 0.023 | 5.3 |
| | 18 | 0.040 | 1.72 | 0.78 | 0.030 | 0.0004 | 7.9 | 14.4 | 0.75 | 1.3 | [symbol] | 0.34 | 0.33 | 0.013 | 0.006 | 0.025 | 6.1 |
| | 19 | 0.041 | 1.30 | 0.88 | 0.025 | 0.0007 | 6.5 | 13.5 | 0.81 | 0.77 | [symbol] | 0.39 | 0.31 | 0.013 | 0.004 | 0.020 | 6.1 |
| | 20 | 0.038 | 1.40 | 0.92 | 0.030 | 0.0009 | 7.2 | 14.5 | 0.72 | 1.0 | [symbol] | [symbol] | 0.28 | 0.017 | [symbol] | 0.031 | 6.4 |
| Compar- | 21 | 0.038 | 1.44 | 0.83 | 0.030 | (0.0025) | 7.0 | 14.7 | 0.72 | (6.2) | (0.002) | (0.13) | (0.12) | 0.003 | 0.005 | 0.059 | 1.5 |
| ative | 22 | 0.041 | [symbol] | 0.85 | 0.017 | 0.0007 | [symbol] | 13.6 | 0.81 | 2.5 | (0.258) | 0.31 | 0.39 | (0.035) | 0.004 | 0.058 | 6.7 |
| Examples | 23 | [symbol] | [symbol] | [symbol] | 0.029 | [symbol] | 7.9 | 13.9 | 0.86 | [symbol] | 0.006 | 0.30 | 0.20 | 0.029 | 0.011 | (0.061) | 1.1 |
| | 24 | [symbol] | [symbol] | 1.13 | 0.020 | 0.0010 | 7.4 | [symbol] | 0.76 | 1.4 | 0.008 | 0.25 | 0.21 | 0.014 | 0.006 | 0.027 | (0.1) |
| | 25 | [symbol] | [symbol] | 0.89 | 0.027 | 0.0003 | [symbol] | 15.7 | 0.74 | 1.9 | (0.288) | 0.31 | 0.24 | 0.007 | 0.012 | 0.024 | (10.9) |
| | 26 | 0.038 | [symbol] | 1.04 | 0.029 | 0.0013 | 8.4 | [symbol] | 0.86 | 0.85 | 0.008 | (0.48) | 0.30 | 0.009 | 0.007 | 0.017 | 2.7 |
| | 27 | 0.038 | [symbol] | [symbol] | 0.020 | 0.0006 | 7.3 | 14.0 | 0.72 | [symbol] | 0.006 | 0.28 | 0.36 | 0.018 | 0.012 | 0.036 | [symbol] |
| | 28 | 0.048 | [symbol] | 1.24 | 0.017 | 0.0009 | [symbol] | 13.2 | [symbol] | 0.61 | 0.007 | 0.26 | 0.44 | 0.018 | 0.014 | 0.023 | (0.4) |
| | 29 | 0.040 | 1.82 | 0.88 | 0.030 | (0.0031) | 7.9 | 14.4 | 0.75 | 1.3 | (0.004) | (0.12) | (0.14) | 0.013 | 0.006 | 0.025 | 4.5 |
| | 30 | 0.038 | 1.90 | (0.45) | 0.030 | 0.0012 | 7.2 | 11.3 | 0.72 | 3.2 | 0.007 | 0.36 | 0.28 | 0.012 | 0.015 | 0.040 | 1.1 |

| | | Ca | O | B | Mg | [symbol] | SiO₂ | CaO | MgO | Al₂O₃ | TiO₂ | NbO | F | Total | Remarks |
|---|---|---|---|---|---|---|---|---|---|---|---|---|---|---|---|
| Examples | 1 | 0.0005 | 0.0063 | | 0.008 | −0.27 | 8.3 | 62.0 | 12.5 | 12.0 | 0.3 | 0.2 | 3.7 | 98.0 | |
| | 2 | 0.0004 | 0.0002 | | 0.011 | 0.33 | 19.2 | 42.3 | 19.8 | 8.8 | 0.7 | 0.4 | [symbol] | 99.3 | |
| | 3 | 0.0023 | 0.0002 | | 0.013 | 0.07 | [symbol] | 67.3 | 7.3 | 12.3 | 0.1 | 0.1 | [symbol] | 93.1 | |
| | 4 | 0.0018 | 0.0008 | | 0.007 | −0.02 | 18.3 | 50.6 | 10.3 | 12.3 | 0.8 | 0.8 | 5.2 | 98.3 | |
| | 5 | 0.0002 | 0.0054 | | 0.0003 | 0.13 | 18.3 | 43.9 | 15.3 | 19.3 | 0.7 | 0.7 | 1.2 | 99.4 | |
| | 6 | 0.0024 | 0.0001 | | 0.014 | 0.08 | 7.2 | 66.3 | 8.2 | 8.7 | 0.1 | 0.1 | [symbol] | 99.4 | |
| | 7 | 0.0001 | 0.0078 | | 0.0005 | 0.00 | 13.3 | 56.7 | 6.9 | 16.9 | 0.8 | 0.7 | 5.6 | 99.9 | |
| | 8 | 0.0020 | 0.0002 | | 0.009 | 0.12 | 4.2 | 68.7 | 6.3 | 13.5 | 0.2 | 0.1 | 6.3 | 99.3 | |
| | 9 | 0.0019 | 0.0003 | | 0.0081 | 0.18 | 10.2 | 66.3 | 10.2 | 8.3 | 0.2 | 0.1 | 3.8 | 99.1 | |
| | 10 | 0.0002 | 0.0083 | | 0.0001 | 0.08 | 17.3 | 46.3 | 17.3 | 15.3 | 0.5 | 0.7 | [symbol] | 99.2 | |
| | 11 | 0.0001 | 0.0092 | | 0.0002 | 0.08 | 19.8 | 42.1 | 18.6 | 11.3 | 0.9 | 0.3 | 5.9 | 99.9 | |
| | 12 | 0.0009 | 0.0003 | | 0.0009 | −0.01 | 19.8 | 43.1 | 15.3 | 12.8 | 0.8 | 0.3 | 5.3 | [symbol] | |
| | 13 | 0.0000 | 0.0069 | | 0.0001 | −0.01 | [symbol] | 52.3 | 7.7 | 15.9 | 0.8 | 0.7 | 5.5 | [symbol] | |
| | 14 | 0.0021 | 0.0002 | | 0.007 | −0.08 | 2.3 | 69.3 | 8.2 | 10.5 | 0.1 | 0.1 | [symbol] | [symbol] | |
| | 15 | 0.0002 | 0.0053 | | 0.120 | 0.01 | 18.9 | 42.8 | 14.3 | 18.1 | 0.5 | 0.5 | 4.2 | [symbol] | |
| | 16 | 0.0001 | 0.0025 | 0.0015 | 0.0002 | 0.08 | 17.3 | 43.8 | 15.3 | 18.3 | 0.7 | 0.7 | 3.4 | 99.6 | |
| | 17 | 0.0002 | 0.0057 | 0.0010 | 0.0003 | 0.18 | 18.4 | 42.3 | 16.3 | 18.3 | 0.5 | 0.6 | [symbol] | 99.2 | |
| | 18 | 0.0000 | 0.0025 | 0.0013 | 0.0002 | −0.01 | 19.3 | 43.9 | 15.3 | 18.3 | 0.0 | 0.5 | 1.2 | 99.1 | |
| | 19 | 0.0001 | 0.0042 | 0.0019 | 0.0003 | −0.08 | 19.8 | 42.6 | 16.3 | 18.3 | 0.7 | 0.7 | 1.2 | 99.6 | |
| | 20 | 0.0002 | [symbol] | | 0.0002 | −0.08 | 19.8 | 40.6 | 16.2 | 18.3 | 0.6 | 0.5 | 3.2 | 99.1 | |
| Compar- | 21 | 0.0001 | (0.0152) | | (0.0000) | 0.08 | (24.3) | (38.2) | 16.3 | 18.3 | 1.8 | 1.6 | 1.2 | 99.7 | Cu out of |
| ative | | | | | | | | | | | | | | | the range |
| Examples | 22 | (0.0035) | 0.0001 | | (0.0168) | −0.01 | 3.8 | 59.5 | 6.7 | (21.3) | 0.1 | 0.1 | 3.2 | 99.7 | Sn out of |
| | | | | | | | | | | | | | | | the range |
| | 23 | 0.0003 | 0.0025 | | 0.0012 | −0.01 | 19.3 | 43.9 | 15.3 | 16.3 | 0.6 | 0.5 | 1.2 | 99.1 | Cu, Sn out |
| | | | | | | | | | | | | | | | of the range |
| | 24 | 0.0002 | 0.0036 | | 0.0012 | −0.04 | 17.3 | 46.3 | 12.3 | 15.8 | 0.5 | 0.7 | 6.3 | 99.2 | [symbol] cal out |
| | | | | | | | | | | | | | | | of the range |
| | 25 | (0.0050) | 0.0001 | | 0.0123 | −0.07 | (0.5) | (72.9) | 5.8 | 15.4 | 0.1 | 0.1 | 4.9 | 99.7 | Al out of |
| | | | | | | | | | | | | | | | the range |
| | 26 | 0.0003 | 0.0001 | | 0.0005 | −0.18 | 19.8 | 41.9 | 19.3 | 11.2 | 0.3 | 0.6 | 5.9 | 99.0 | Ti out of |
| | | | | | | | | | | | | | | | the range |
| | 27 | 0.0001 | 0.0056 | | 0.0002 | 0.08 | 18.8 | 41.8 | 19.3 | 11.2 | 0.3 | 0.6 | 5.9 | [symbol] | Si out of |
| | | | | | | | | | | | | | | | the range |
| | 28 | 0.0003 | 0.0025 | | 0.0001 | 0.18 | 17.2 | 46.3 | 12.3 | 15.8 | 0.5 | 0.7 | 6.3 | 99.2 | Si out of |
| | | | | | | | | | | | | | | | the range |
| | 29 | 0.0002 | (0.0124) | | 0.0001 | 0.02 | 19.3 | 43.2 | 15.1 | 17.8 | 1.3 | 1.4 | 1.7 | 99.3 | S out of |
| | | | | | | | | | | | | | | | the range |
| | 30 | 0.0001 | 0.0026 | | 0.0002 | −0.08 | 16.8 | 52.3 | 7.7 | 15.9 | 0.8 | 0.7 | 5.5 | 99.8 | Mn out of |
| | | | | | | | | | | | | | | | the range |

[symbol]

indicates data missing or illegible when filed

It should be noted that among these elements, chemical components other than C, S, and N were analyzed by X-ray fluorescence analysis. N was analyzed by an inert gas-impulse heating melting method, and C and S were analyzed by combustion in an oxygen gas flow-infrared absorption method. It should be noted that blanks in the Table indicate that the component was deliberately not added.

Each of compositions in the slag was analyzed by X-ray fluorescence analysis. It should be noted that since the slag contains minor components such as Mn, P, and S, the total of each of slag component is less than 100%.

After that, the slab was heated at 900 to 1250° C. and was hot-rolled so as to obtain a hot-rolled coil of thickness of 6.5 mm. Subsequently, solution heat treatment of this hot-rolled coil was performed, the coil was processed by acid pickling, and further, was cold-rolled, and the final solution heat treatment and acid pickling process were performed, so as to obtain a cold-rolled coil of plate thickness of 5.3 mm. The solution heat treatment was performed under conditions in which the coil was held at 1050° C. for 3 minutes and then cooled by water. Samples were collected from the coil for evaluation.

### 1. Bead-On-Plate Test

In order to align plate thickness, thickness was adjusted to 5.0 mmt by a shaper. Surface finishing was “∇∇∇” (Japanese Industrial Standard symbol). Conditions of bead-on-plate test of one pass by TIG welding were set as follows, welding current: 125 Å, welding speed: 80 mm/min, seal gas: Ar+3% H₂, 15 L/min. With respect to the welded sample, (1) depth of weld penetration and width were evaluated by observation of cross section and (2) appearance (concave and convex parts) was evaluated.

Regarding the evaluation (1), embedded samples were prepared, the cross section thereof was observed by an optical microscope, and weld penetration depth and bead width were evaluated. It is desirable that weld penetration depth be deep and that bead width be not too wide in the evaluation, and therefore, evaluation was categorized as A to D as shown in the Table as an overall evaluation.

TABLE 3

| | | Not less | 7.5 to | 6.5 to | Less than |
|---|---|---|---|---|---|
| | Bead width | than 8.5 mm | 8.5 mm | 7.5 mm | 6.5 mm |
| Melting and absorbing | Evaluation | D | C | B | A |
| Less than 3 mm | D | D | D | D | D |
| 3 to 4 mm | C | D | C | C | B |
| 4 to 5 mm | B | D | C | B | A |
| Not less than 5 mm | A | D | B | A | A |

Regarding the evaluation (2), a location near a finishing point, at which a welding bead after welding was sufficiently stabilized, was selected, number of concave and convex parts having height of not less than 0.2 mm in a bead length 30 mm was measured by a color 3D laser microscope (trade name: VK-9719, produced by Keyence corporation) and was evaluated. A sample in which the number was fewer than 15 parts was evaluated as A, a sample in which the number was 15 to 25 parts was evaluated as B, a sample in which the number was 26 to 29 parts was evaluated as C, and a sample in which the number was not fewer than 30 parts was evaluated as D.

### 2. Varestraint Test

Size of the Trans-varestraint test piece was 5.0 t×65 w×130l, and the testing apparatus was BTM-380 produced by MIYAKOJIMA SEISAKUSHO CO., LTD. Conditions of TIG welding were set to be welding current 120 A, welding speed 100 mm/min, seal gas Ar, and flow amount 15 L/min. Since bending jig of 500 R was used, it was calculated that distortion of 0.5% was imparted at the surface. Distorting rate was set to be 10 mm/sec. Evaluation of test results was performed by occurrence of cracking, a measurement of entire length of cracking by observation at 50 times magnification if there was cracking, and a total cracking length which is the sum of the cracks. A sample in which cracking did not occur was evaluated as A, a sample in which cracking occurred and total cracking length was not more than 1 mm was evaluated as B, a sample in which total cracking length was more than 1 mm and not more than 2 mm was evaluated as C, and a sample in which total cracking length was more than 2 mm was evaluated as D.

### 3. Hot Workability

Occurrence of surface defects such as sliver on a flat surface of a coil on which hot rolling was performed was observed visually with respect to an upper surface and a lower surface, and they were evaluated. The evaluation process was after annealing-acid pickling, and was based on visual observation. A sample in which there were not more than 3 defects per 200 m was evaluated as A, a sample in which there were 4 to 10 defects was evaluated as B, a sample in which there were 11 to 20 defects was evaluated as C, and a sample in which there were more than 20 defects confirmed was evaluated as D.

TABLE 4

| | | Bead on | | | | | |
|---|---|---|---|---|---|---|---|
| | | | | | Concave | Varestraint | Hot |
| | | Total | Depth | Width | and Convex | test | workability |
| Examples | 1 | C | C | B | C | B | C |
| | 2 | B | A | C | C | B | B |
| | 3 | A | A | B | C | C | B |
| | 4 | C | C | C | B | B | C |
| | 5 | A | A | B | B | B | C |
| | 6 | C | C | C | C | C | B |
| | 7 | A | A | B | B | C | B |
| | 8 | A | B | A | A | A | B |
| | 9 | A | B | A | A | A | B |
| | 10 | B | B | B | A | A | B |
| | 11 | A | B | A | A | A | B |
| | 12 | A | B | A | B | B | B |
| | 13 | B | B | B | B | A | B |
| | 14 | A | B | A | C | A | B |
| | 15 | B | B | B | B | B | A |
| | 16 | A | B | A | A | A | A |
| | 17 | A | B | A | A | A | A |
| | 18 | B | B | B | B | A | A |
| | 19 | B | B | B | C | C | A |
| | 20 | A | B | A | C | A | A |
| Comparative | 21 | B | E | B | B | D | D |
| Examples | 22 | B | B | B | D | D | C |
| | 23 | A | A | B | B | D | C |
| | 24 | B | A | C | B | D | D |
| | 25 | B | B | B | D | B | D |
| | 26 | A | A | B | D | C | D |
| | 27 | B | B | B | D | D | D |
| | 28 | D | D | C | B | B | B |
| | 29 | D | B | D | C | D | D |
| | 30 | D | B | D | C | B | B |

Samples Nos. 1 to 20 satisfied requirements of component ranges and the relationship formulas of the present invention, and therefore, there was no problem in each of the properties. In particular, Samples Nos. 16 to 19 containing B exhibited superior hot workability. In addition, samples satisfying Nb−Ti>0 had good tendency of concave and convex parts of the welding beads, although not every combination of sample and its result were in agreement because of effects of other components (comparison was performed for Samples Nos. 8 to 20).

On the other hand, since Cu was out of the range in Comparative Example No. 21, cracking occurred at a welded part and was evaluated to have inferior hot workability. Furthermore, since CaO concentration in the slag was low and Al was out of the range, being too low, S concentration and oxygen concentration were out of the range, being too high. Therefore, TiO₂ and NbO in the slag were also high, Ti and Nb concentrations were below the range of the invention, and a predetermined aging hardening was not exhibited. Furthermore, Mg being below 0.0001% resulted in deterioration of hot workability.

Since Sn was out of the range of the invention in Comparative Example No. 22, cracking occurred at a welded part. Furthermore, since Al was out of the range, being too high, Ca and Mg concentrations were out of the range, being too high. Therefore, properties of the welding bead was evaluated as being inferior.

Since the relationship formula (1) of Sn and Cu was not satisfied in Comparative Example No. 23, cracking occurred at a welded part.

Since the relationship formula (2) controlling microstructure was not satisfied in Comparative Example No. 24, hot workability was deteriorated and cracking occurred at a welded part.

Since Al content was out of the range, being too high, and CaO concentration in the slag was out of the range, being too high, in Comparative Example No. 25, Ca was supplied to the molten metal at high concentration. Therefore, bead quality was deteriorated.

Since Ti content was above the range of the invention in Comparative Example No. 26, a concave and convex part on the surface of bead was large, being in an inferior bead surface condition, which required correction. Hot workability was also inferior.

Since Si content was greater than the range of the invention in Comparative Example No. 27, concave and convex part on the surface of bead was large, cracking was also observed, and welding properties were inferior. In addition, hot workability was also inferior.

Since Si content was below the range of the invention in Comparative Example No. 28, and therefore, weld penetration depth was low, and it was at an inappropriate level to weld a thick plate.

Since the Al content was below the range of the invention in Comparative Example No. 29, the sulfur and oxygen concentrations were out of range, being too high. Furthermore, since TiO₂ and NbO in the slab were also high, Ti and Nb concentrations were below the lower limit. In particular, the amount of S was out of the range of the invention, the welding bead tended to be extremely wide, the welding bead had an inferior shape and it was in an inappropriate level. Furthermore, cracking was confirmed on the welding bead, and hot workability was also inferior.

Since the Mn amount was below the range of the invention in Comparative Example No. 30, the welding bead tended to be extremely wide, the welding bead had an inferior shape and it was in an inappropriate level.

1. A precipitation hardening martensitic stainless steel consisting of:
in mass %, C: 0.030 to 0.065%, Si: 1.0 to 2.0%, Mn: 0.51 to 1.50%, P: not more than 0.04%, S: not more than 0.0020%, Ni: 4.0 to 10.0%, Cr: 11.0 to 18.0%, Mo: 0.1 to 1.50%, Cu: 0.30 to 6.0%, Al: 0.005 to 0.2%, Sn: 0.003 to 0.030%, N: 0.001 to 0.015%, Ti: 0.15 to 0.45%, Nb: 0.15 to 0.55%, Ca: not more than 0.0025%, Mg: 0.0001 to 0.0150%, O: not more than 0.01% and Fe and inevitable impurities as a remainder, and
satisfying the following formula (1). and δcal. (%) defined by the formula (2) is in a range of 1.0 to 9.0:
$$Sn + 0.009 Cu \leq 0.06 \qquad ( 1 )$$
$$δ cal . ( vol . \% ) = 4.3 ( 1.3 Si + Cr + Mo + 2.2 Al + Ti + Nb ) - 3.9 ( 30 C + 30 N + Ni + 0.8 Mn + 0.3 Cu ) - 31.5 . \qquad ( 2 )$$

2. The precipitation hardening martensitic stainless steel according to claim 1, wherein B: 0.0010 to 0.0020% is contained.

3. The precipitation hardening martensitic stainless steel according to claim 1 or 2, wherein the formula (3) is satisfied.
$$Nb - Ti > 0. \qquad ( 3 )$$

4. A method for production of the precipitation hardening martensitic stainless steel according to any one of claims 1 to 3, comprising the steps of:
melting raw material of Ni alloy scrap, iron scrap or stainless scrap, ferrochromium, ferronickel, pure nickel, metallic chromium in an electric furnace,
blowing oxygen gas and/or argon gas to perform decarburization and refining in an AOD furnace or VOD furnace in which magnesia-chrome or dolomite is lined as a refractory material,
forming CaO—SiO₂—Al₂O₃—MgO—F type slag comprising CaO: 40 to 70%, SiO₂: 1 to 20%, Al₂O₃: 5 to 20%, MgO: 5 to 20%, F: 1 to 10% and performing desulfurizing and deoxidizing by placing calcined lime, fluorite, Al and Si,
refining in the AOD furnace or VOD furnace by placing a Ti source and a Nb source,
adjusting compositions and temperature in an LF process,
producing a rectangular slab by continuous casting,
hot rolling,
cold rolling, if necessary, and
performing solution heat treatment.

5. The method for production of the precipitation hardening martensitic stainless steel according to claim 4, wherein the solution heat treatment is performed at 900 to 1150° C.
